(19) United States
(12) Patent Application Publication
(10) Pub. No.: US 2015/0017495 A1
(43) Pub. Date: Jan. 15, 2015

(54) BATTERY TEMPERATURE REGULATING DEVICE

(71) Applicant: DENSO CORPORATION, Kariya-city, Aichi-pref (JP)

(72) Inventors: Hideaki Okawa, Kariya-city (JP); Hiroshi Kishita, Anjo-city (JP); Takashi Yamanaka, Kariya-city (JP); Masayuki Takeuchi, Nukata-gun (JP)

(21) Appl. No.: 14/373,840

(22) PCT Filed: Dec. 26, 2012
(86) PCT No.: PCT/JP2012/008297

§ 371 Date: Jul. 22, 2014

(30) Foreign Application Priority Data
Jan. 30, 2012 (JP) 2012-016601

(51) Int. Cl. H01M 10/656; H01M 10/0525

(52) U.S. Cl. CPC H01M 10/5061; H01M 10/0525
USPC 429/71

(57) ABSTRACT

A battery temperature regulating device includes batteries, inter-battery passages, and a fluid driving device. The batteries are connected to be capable of energization and arranged in a stacking manner. Each of the inter-battery passages is defined between corresponding adjacent two of the batteries. The fluid driving device is configured to flow temperature regulating fluid for regulating temperature of the batteries through the inter-battery passages. Each of the inter-battery passages includes a first inter-battery passage and a second inter-battery passage. Between the corresponding adjacent two of the batteries, a direction in which temperature regulating fluid flows into the first inter-battery passage and a direction in which temperature regulating fluid flows into the second inter-battery passage are different from each other. A flow direction of temperature regulating fluid flowing through the first inter-battery passage is opposite from a flow direction of temperature regulating fluid flowing through the second inter-battery passage.

### CROSS REFERENCE TO RELATED APPLICATIONS

This application is a U.S. National Phase Application under 35 U.S.C. 371 of International Application No. PCT/JP2012/008297 filed on Dec. 26, 2012 and published in Japanese as WO 2013/114513 on Aug. 8, 2013. This application is based on Japanese Patent Application No. 2012-016601 filed on Jan. 30, 2012. The entire disclosures of all of the above applications are incorporated herein by reference.

### TECHNICAL FIELD

The present disclosure relates to a battery temperature regulating device that regulates temperature of a battery group including batteries by use of fluid flowing therearound.

### BACKGROUND ART

A battery pack described in Patent Literature 1 sets a target width of a refrigerant flow passage such that temperature deviations between battery modules due to manufacturing tolerance of the refrigerant flow passage formed between the battery modules from its target width fall within a predetermined range, and such that temperatures of all the battery modules are a predetermined temperature or lower, when refrigerant flows through the refrigerant flow passage.

Accordingly, even in view of variation among gap sizes between the battery modules, the device maintains a variation in temperature of batteries in the battery pack within a permissible temperature range.

### PRIOR ART LITERATURES

### Patent Literature

### Patent Literature 1 JP-A-2004-31364

The above-described conventional technology sets the target width of the refrigerant flow passage to keep the variation in temperature of batteries within the permissible temperature range. However, it is undeniable that a temperature difference is made between a battery surface on an upstream side and a battery surface on a downstream side in a refrigerant flow direction, which may influence battery performance. For example, in a case of a small refrigerant flow rate, most of cooling capacity of the refrigerant is employed for cooling the upstream battery surface, and the temperature of the downstream battery surface cannot be reduced. For this reason, the temperature difference between battery surfaces on the upstream and downstream sides becomes marked.

### SUMMARY OF INVENTION

It is an object of the present disclosure to provide a battery temperature regulating device that can limit a great temperature difference on a battery surface.

To achieve the above-described object, a battery temperature regulating device in a first mode of the present disclosure includes a plurality of batteries, a plurality of inter-battery passages, and a fluid driving device. The plurality of batteries are connected to be capable of energization and arranged in a stacking manner. Each of the plurality of inter-battery passages is defined between corresponding adjacent two of the plurality of batteries. The fluid driving device is configured to flow temperature regulating fluid for regulating temperature of the plurality of batteries through the plurality of inter-battery passages. Each of the plurality of inter-battery passages includes a first inter-battery passage and a second inter-battery passage. Between the corresponding adjacent two of the plurality of batteries, a direction in which temperature regulating fluid flows into the first inter-battery passage and a direction in which temperature regulating fluid flows into the second inter-battery passage are different from each other. A flow direction of temperature regulating fluid flowing through the first inter-battery passage is opposite from a flow direction of temperature regulating fluid flowing through the second inter-battery passage.

Accordingly, by providing two passages respectively through which the temperature regulating fluid flows in the opposite direction from each other for the inter-battery passage, on a surface of the battery, there are caused at least two regions which receive a great temperature regulating effect and two regions which receive a decreased temperature regulating effect, and temperature differences because of this are made. As described above, according to the present disclosure, since temperature differences can be made at many positions on the battery surface in comparison with the conventional technology in which the temperature regulating fluid flows through the inter-battery passage only in one direction, the heat conductions due to the temperature differences can be actively produced on the battery surface. As a result of promotion of a heat transfer on the battery surface because of this increase in position of heat conduction, the temperature difference on the battery surface can be limited. Therefore, battery temperature regulation which is excellent in performance and life of the battery can be realized.

In a second mode of the present disclosure, the first inter-battery passage is a passage through which temperature regulating fluid flows in one direction on one side of a passage formation surface of one of the corresponding adjacent two of the plurality of batteries and flows out of between the corresponding adjacent two of the plurality of batteries. The second inter-battery passage is a passage which is arranged on the other side of the passage formation surface of one of the corresponding adjacent two of the plurality of batteries that is adjacent to the first inter-battery passage and through which temperature regulating fluid flows in an opposite direction from a direction of temperature regulating fluid flowing through the first inter-battery passage.

Accordingly, on the surface of the battery, regions which receive a great temperature regulating effect are produced on one side and on the other side, and regions which receive a reduced temperature regulating effect are produced on the other side and on one side; and the regions receiving a great effect and the regions receiving a reduced effect are adjacently located respectively, and temperature differences due to this can be made. As a result, the battery temperature regulating device can actively cause the heat conduction due to the temperature difference on the battery surface in a direction of arrangement of the first inter-battery passage and second inter-battery passage. As a result of the promotion of a heat transfer in this direction, the present disclosure can limit the temperature difference on the battery surface.

In a third mode of the present disclosure, the first inter-battery passage is a passage defining a flow route through which temperature regulating fluid flows in, flows back at a certain position between the corresponding adjacent two of the plurality of batteries, and flows out of between the corresponding adjacent two of the plurality of batteries in an opposite direction from an inflow direction of temperature regulating fluid. The second inter-battery passage is a passage defining a flow route through which temperature regulating fluid flows in, in an opposite direction from a direction of the flow of temperature regulating fluid into the first inter-battery passage, flows back at a certain position between the corresponding adjacent two of the plurality of batteries, and flows out of between the corresponding adjacent two of the plurality of batteries in an opposite direction from an inflow direction of temperature regulating fluid.

Accordingly, on the surface of the battery, a region receiving a great temperature regulating effect, and a region receiving a reduced temperature regulating effect are produced adjacently at the fluid inflow part and the fluid outflow part of the first inter-battery passage respectively so that a temperature difference is made; and a region receiving a great temperature regulating effect, and a region receiving a reduced temperature regulating effect are produced adjacently at the fluid inflow part and the fluid outflow part of the second inter-battery passage respectively so that a temperature difference is made. As a result, on the battery surface, the battery temperature regulating device can actively cause the heat conductions due to the temperature differences respectively between the turn-back passages of the first inter-battery passages and between the turn-back passages of the second inter-battery passages. As a result of the promotion of heat transfers in these directions, the present disclosure can limit the temperature differences on the battery surface.

In a fourth mode of the present disclosure, a part of the first inter-battery passage into which temperature regulating fluid flows, and a part of the second inter-battery passage into which temperature regulating fluid flows are arranged diagonally on a passage formation surface of one of the corresponding adjacent two of the plurality of batteries.

Accordingly, on the surface of the battery, the heat conduction due to the temperature difference can actively be caused also between the turn-back part of the first inter-battery passage and the turn-back part of the second inter-battery passage in addition to the heat conductions due to the temperature differences caused by the third mode. As a result, the present disclosure has the position where heat transfer is further promoted on the battery surface, so that the effect of limiting the temperature difference on the battery surface can be further enhanced.

In a fifth mode of the present disclosure, the first inter-battery passage is a passage through which temperature regulating fluid flows in one direction from one side toward the other side of a passage formation surface of one of the corresponding adjacent two of the plurality of batteries. The second inter-battery passage is a passage through which temperature regulating fluid flows in an opposite direction from a direction of temperature regulating fluid flowing through the first inter-battery passage from the other side toward the one side of the passage formation surface of one of the corresponding adjacent two of the plurality of batteries. Each of the plurality of inter-battery passages further includes a third inter-battery passage through which temperature regulating fluid flowing through the first inter-battery passage and temperature regulating fluid flowing through the second inter-battery passage merge together to flow down.

Accordingly, on the surface of the battery, regions receiving a great temperature regulating effect, and regions receiving a reduced temperature regulating effect are produced respectively at the fluid inflow part of the first inter-battery passage and the merging part of the third inter-battery passage; and at the fluid inflow part of the second inter-battery passage and the merging part of the third inter-battery passage, so that temperature differences due to these can be made. As a result, on the surface of the battery, the battery temperature regulating device can actively cause the heat conductions due to the temperature differences respectively between one side part and the merging part and between the other side part and the merging part. The present disclosure can limit the temperature differences on the battery surface by the promotion of heat transfers in these directions.

### BRIEF DESCRIPTION OF DRAWINGS

The above and other objects, features and advantages of the present disclosure will become more apparent from the following detailed description made with reference to the accompanying drawings. In the drawings:

FIG. 1 is a perspective view illustrating a configuration of a battery temperature regulating device and flow directions of temperature regulating fluid in a first embodiment;

FIG. 2 is a schematic view illustrating the flow directions of temperature regulating fluid and directions of heat conduction for a battery when cooled in the first embodiment;

FIG. 3 is a schematic view illustrating the flow directions of temperature regulating fluid and the directions of heat conduction for the battery when warmed in the first embodiment;

FIG. 4 is a perspective view illustrating a configuration of a battery temperature regulating device and flow directions of temperature regulating fluid in a second embodiment;

FIG. 5 is a perspective view illustrating a configuration of a battery temperature regulating device and flow directions of temperature regulating fluid in a third embodiment;

FIG. 6 is a schematic view illustrating the flow directions of temperature regulating fluid and directions of heat conduction for a battery when cooled in the third embodiment;

FIG. 7 is a schematic view illustrating the flow directions of temperature regulating fluid and the directions of heat conduction for the battery when warmed in the third embodiment;

FIG. 8 is a perspective view illustrating a configuration of a battery temperature regulating device and flow directions of temperature regulating fluid in a fourth embodiment;

FIG. 9 is a schematic view illustrating the flow directions of temperature regulating fluid and directions of heat conduction for a battery when cooled in the fourth embodiment;

FIG. 10 is a schematic view illustrating the flow directions of temperature regulating fluid and the directions of heat conduction for the battery when warmed in the fourth embodiment; and

FIG. 11 is a schematic view illustrating a temperature distribution that can be caused on a battery surface with respect to a flow of temperature regulating fluid in a conventional example.

### EMBODIMENTS FOR CARRYING OUT INVENTION

Embodiments will be described below with reference to the drawings. In each embodiment, for a part corresponding to the matter described in the preceding embodiment, the same reference numeral may be used to omit a repeated explanation. In each embodiment, when only a part of configuration is described, another embodiment explained ahead of the embodiment can be applied to the other part of the configuration. In the embodiments, in addition to combination between parts which are specifically shown to be combinable, embodiments can be combined partially with each other even if not expressly shown as long as the combination does not particularly create problems.

### First Embodiment

A battery temperature regulating device of the present disclosure is used for a hybrid automobile with an internal combustion engine and a motor driven by electric power, with which a battery is charged, serving in combination as its traveling driving source, an electric automobile with a motor as its traveling driving source, a household equipment, or an industrial equipment, for example. A battery whose temperature is regulated is used for, for example, the purpose of accumulating electric power stored by a solar battery panel, a commercial power supply or the like and using the electric power when needed, in addition to the purpose of supply of electric power to a motor for traveling. The electric power is stored in batteries which constitute a battery group. Each battery is, for example, a nickel hydrogen secondary battery, a lithium ion secondary battery, or an organic radical cell, and they are arranged for example, under a seat, in a space between a rear seat and a trunk room, or in a space between a driver's seat and a passenger seat, in an automobile in their in-housing accommodated state, and are also arranged for example, near an energy management device, a solar battery panel system or the like.

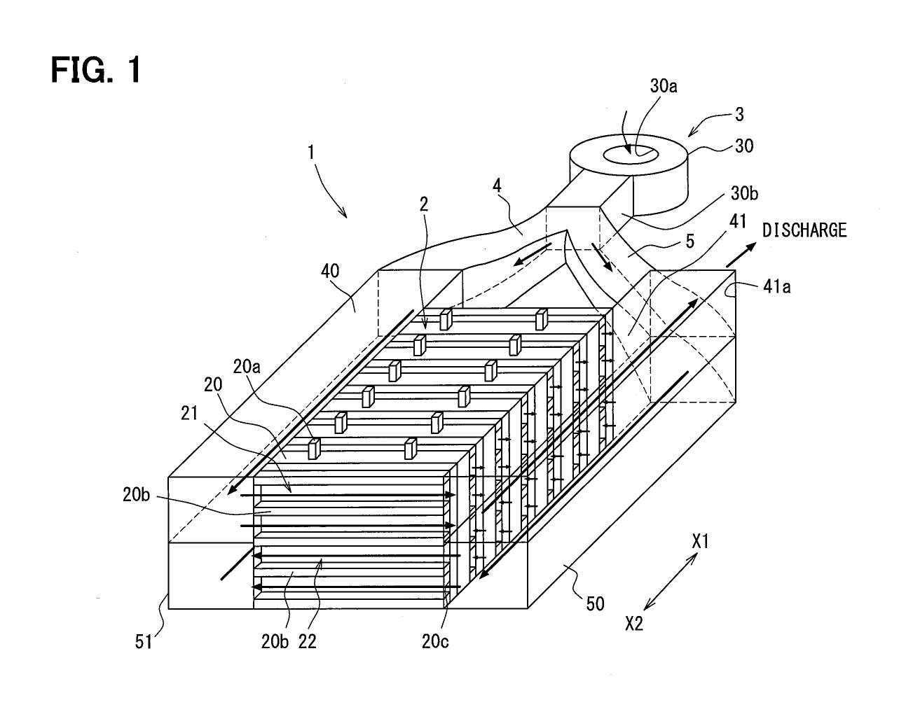

A first embodiment will be described with reference to FIGS. 1 to 3 and 11. FIG. 1 is a perspective view illustrating configuration of a battery temperature regulating device 1 and a flow direction of temperature regulating fluid according to the first embodiment. In FIG. 1, the flows of the temperature regulating fluid are indicated by arrows, and a part of a battery 20 that cannot be seen from the outside under ordinary circumstances is indicated by a continuous line to assist in easily understanding passages between batteries. In the first embodiment, air is employed as an example of the temperature regulating fluid which is used for regulating the temperature of the battery.

The battery temperature regulating device 1 includes a battery group 2 having batteries 20 connected to be capable of energization, and a blower 3 which blows air through the passages between the batteries. The blower 3 is an example of a fluid flowing device that makes the air for regulating the temperature of the battery 20 flow through the passages between the batteries which are formed between the adjacent batteries. A control device, which is not shown, can control an air volume of air through the blower 3 by regulating a rotating speed of the blower 3.

The battery group 2, in which the batteries 20 are stacked, is controlled by an electronic component (not shown) used for charge, discharge, and temperature regulation of the batteries 20, and the batteries 20 are cooled by the air flowing through the passages between the batteries. This electronic component includes an electronic component for controlling a relay, an inverter of a battery charger and so forth, a battery monitoring device, a battery protection circuit, and various kinds of control devices.

The battery 20 includes, for example, an exterior case having a shape of a flat rectangular parallelepiped, and has an electrode terminal 20a that projects from its upper end surface that is parallel to the thickness direction and narrow into the outside. The electrode terminal 20a includes a positive pole terminal and a negative pole terminal provided for each battery 20 with a predetermined distance therebetween. All the batteries 20 which constitute the battery group 2 are series-connected to be capable of energization from a negative pole terminal of the battery 20 that is located on one end side in their stacking direction, through a busbar connecting the electrode terminals of the adjacent batteries 20, to a positive pole terminal of the battery 20 that is located on the other end side in the stacking direction.

On a surface opposed to its adjacent battery 20, the battery 20 includes ribs 20b extending in a direction perpendicular to a projecting direction of the electrode terminal 20a and arranged at intervals in this projecting direction. A clearance between the adjacent ribs 20b is configured as a passage through which the air blown by the blower 3 flows in a state of the battery group 2, in which the batteries 20 are stacked. A surface of the battery 20 opposed to its adjacent battery 20 is a passage formation surface 20c of the battery that forms a passage for an air flow between the batteries. Between the passage formation surfaces 20c of the opposed batteries, inter-battery passages obtained by dividing a space between the adjacent batteries by the ribs 20b are provided to be arranged in the projecting direction of the electrode terminal 20a. Each inter-battery passage extends parallel to the rib 20b in a direction perpendicular to the projecting direction of the electrode terminal 20a. The ribs 20b and the inter-battery passages are formed in a rail shape extending in a flow direction of air and extend over the whole region of the passage formation surface 20c of the battery (entire surface opposed to its adjacent battery 20).

Furthermore, the inter-battery passages include a first inter-battery passage 21 and a second inter-battery passage 22 whose air inflow directions are different from each other between the batteries. The first inter-battery passages 21 are passages that occupy half of each space between the batteries on the electrode terminal 20a-side, and the second inter-battery passages 22 are passages that occupy half of each space between the batteries on a farther side from the electrode terminal 20a. The first inter-battery passage 21 and second inter-battery passage 22 are respectively configured by at least one passage defined between the ribs 20b.

The blower 3 includes a sirocco fan, a scroll casing 30 having therein the sirocco fan, and a motor which rotates the sirocco fan. The scroll casing 30 includes a suction port 30a on its upper surface and a blow-out part 30b extending in the centrifugal direction. The blower 3 is disposed at a position away from the battery group 2 in a stacking one direction X1 in which the stacked batteries 20 are arranged.

A two-way duct part is connected to the blow-out part 30b. One of the two-way duct part is configured as a first branch passage 4 through which the air passing through the first inter-battery passage 21 flows, and the other one of the two-way duct part is configured as a second branch passage 5 through which the air passing through the second inter-battery passage 22 flows. The surrounding air drawn into the suction port 30a by the blower 3 is blown out into the first branch passage 4 and second branch passage 5.

The first branch passage 4 is connected to an inflow side duct 40 which is disposed to cover the entire upper half of a lateral part of the battery group 2. The inside of the inflow side duct 40 communicates with the first inter-battery passages 21 arranged at intervals in the stacking one direction X1 at the entire upper half of the lateral part of the battery group 2. In other words, the inflow side duct 40 is provided to cover all the inlet parts of the first inter-battery passages 21. The outlet parts of the first inter-battery passages 21 are arranged to be covered with an outflow side duct 41 at the entire upper half of the lateral part of the battery group 2 on the opposite side from the inflow side duct 40. In other words, the passage in the outflow side duct 41 communicates with all the first inter-battery passages 21. A discharge port 41a through which the air flowing out of the first inter-battery passages 21 is discharged into the outside opens at the end of the outflow side duct 41 located in the stacking one direction X1.

As a result of the above-described configuration, the air drawn into the suction port 30a by the blower 3 branches in two directions at the two-way duct part and flows into the inflow side duct 40 from the one (first) branch passage 4 to flow forward in the inflow side duct 40 in a stacking other direction X2 which is the opposite direction of the stacking one direction X1 and also to flow into each of the first inter-battery passages 21. The air which has flowed out of the first inter-battery passages 21 flows forward through the passage in the outflow side duct 41 in the stacking one direction X1 and is discharged into the outside through the discharge port 41a.

The second branch passage 5 is connected to the inflow side duct 50 disposed to cover the entire lower half of the lateral part of the battery group 2 that is adjacent to the outflow side duct 41. The passage in the inflow side duct 50 communicates with the second inter-battery passages 22 arranged at intervals in the stacking one direction X1 at the entire lower half of the lateral part of the battery group 2. In other words, the inflow side duct 50 is disposed to cover all the inlet parts of the second inter-battery passages 22. The outlet parts of the second inter-battery passages 22 are arranged to be covered by an outflow side duct 51 on the opposite side from the inflow side duct 50 at the entire lower half of the lateral part of the battery group 2 that is adjacent to the inflow side duct 40. In other words, the inside of the outflow side duct 51 communicates with all the second inter-battery passages 22. A discharge port (not shown) through which the air flowing out of the second inter-battery passages 22 is discharged into the outside opens at the end of the outflow side duct 51 located in the stacking one direction X1.

As a result of the above-described configuration, the air drawn into the suction port 30a by the blower 3 flows into the inflow side duct 50 from the other (second) branch passage 5 at the two-way duct part to flow forward inside the inflow side duct 50 in the stacking other direction X2 and also to flow into each of the second inter-battery passages 22. The air flowing out of the second inter-battery passages 22 flows forward in the outflow side duct 51 in the stacking one direction X1 to be discharged into the outside through the discharge port. As described above, there are formed air flows whose directions are opposite from each other along an air flow route running through the first inter-battery passages 21 formed at the upper half of the battery group 2, and along an air flow route running through the second inter-battery passages 22 formed at the lower half of the battery group 2.

For example, by coupling restriction plates (not shown) disposed at both ends in the stacking direction of the batteries 20 by a rod (not shown) or the like, the batteries 20 which constitute the battery group 2 receive compressive force by external force applied inward from both these ends to be restrained and integrally configured. When the restraining force in the stacking direction is applied to the batteries 20 by the restraint device, the ribs 20b are respectively in contact with the passage formation surface 20c of the adjacent battery to receive the force applied from this adjacent battery 20. The ribs 20b have strength that receives the force in a compression direction by the restraining force when in contact with the passage formation surface 20c of the adjacent battery. The ribs 20b have a function that can increase a heat transmission area of the battery 20.

The rib 20b may be a projection formed integrally with the exterior case of the battery 20, or may be a mode that is provided for a different plate member which is a separate part from the exterior case of the battery 20. The different plate member can be provided on the passage formation surface of the battery 20 by integral molding such as insert molding. The exterior case, with which the rib 20b is formed integrally, is formed from, for example, resin having insulation properties, and can be formed from resin such as polypropylene, polyethylene, polystyrene, vinyl chloride, fluorine system resin, PBT, polyamide, polyamidoimide (PAI resin), ABS resin (copolymerize synthetic resin of acrylonitrile, butadiene, and styrene), polyacetal, polycarbonate, polybutylene terephthalate, polyethylene terephthalate, polyphenylenesulfide, phenol, epoxy, or acrylic.

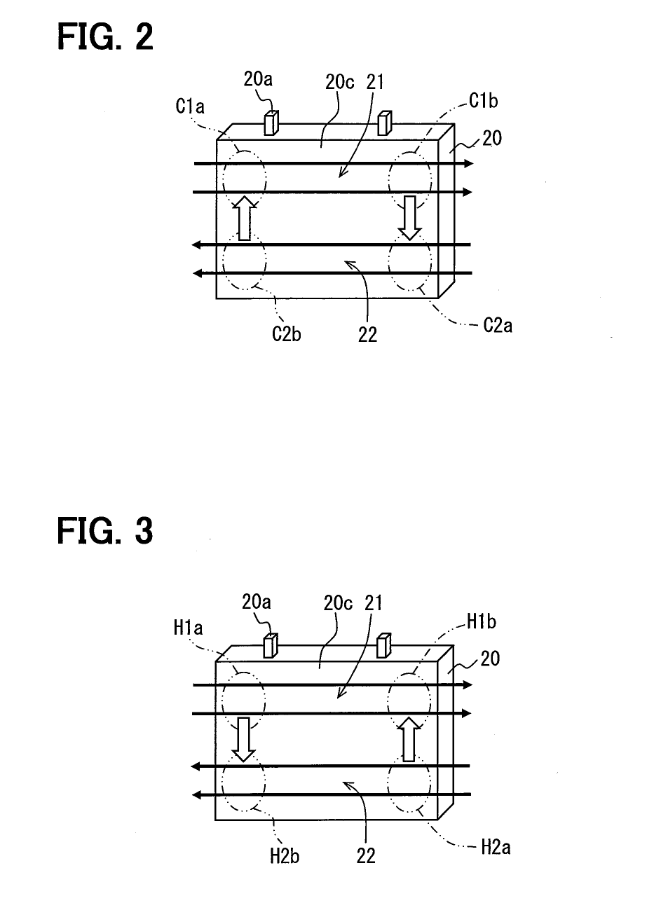

The air flowing at the same time through the first inter-battery passage 21 and second inter-battery passage 22 by the blower 3 warms up each battery 20 when supplied to both the passages after the air is heated by a heating element such as an electric heater or a heat exchanger. The air cools each battery 20 when supplied to both the passages without the air particularly heated. FIG. 2 is a schematic view illustrating a direction of air and a direction of heat conduction relative to the battery 20 at the time of cooling the battery. FIG. 3 is a schematic view illustrating an air flow direction and a direction of heat conduction relative to the battery 20 at the time of warming the battery.

As illustrated in FIG. 2, the air blown via the first branch passage 4 and the inside of the inflow side duct 40 by the blower 3 at the time of cooling the battery flows into each first inter-battery passage 21 arranged on the upper half side of the battery group 2, first to remove the heat of the battery surface at the inlet side part of the first inter-battery passage 21, thereby cooling the battery. Then, the air flows through the first inter-battery passage 21, in contact with the passage formation surface 20c of the battery, to continue to remove the heat of the battery surface, and lastly removes the heat of the battery surface at the outlet side part of the first inter-battery passage 21. Meanwhile, the amount of heat absorbed by the air from the battery surface becomes smaller from the inlet side part toward the outlet side part of the passage. Accordingly, at the time of cooling the battery, a cooling effect is greater at a region closer to the inlet part of the first inter-battery passage 21, and the cooling effect is further reduced at a region closer to the outlet part of the passage 21. Thus, in FIG. 2, the effect of cooling the battery surface is greater at a region surrounded by an alternate long and two short dashes line indicated by C1a (hereinafter referred to as a C1a region) than at a region surrounded by an alternate long and two short dashes line indicated by C1b (hereinafter referred to as a C1b region).

On the other hand, at the time of cooling the battery, the air blown via the second branch passage 5 and the inside of the inflow side duct 50 by the blower 3 flows into each second inter-battery passage 22 arranged on the lower half side of the battery group 2 first to remove the heat of the battery surface at the inlet side part of the second inter-battery passage 22, thereby cooling the battery. Then, the air flows through the second inter-battery passage 22, in contact with the passage formation surface 20c of the battery, to continue to remove the heat of the battery surface, and lastly removes the heat of the battery surface at the outlet side part of the second inter-battery passage 22. Meanwhile, the amount of heat absorbed by the air from the battery surface becomes smaller from the inlet side part toward the outlet side part of the passage. Accordingly, at the time of cooling the battery, a cooling effect is greater at a region closer to the inlet part of the second inter-battery passage 22, and the cooling effect is further reduced at a region closer to the outlet part of the passage 22. Thus, in FIG. 2, the effect of cooling the battery surface is greater at a region surrounded by an alternate long and two short dashes line indicated by C2a (hereinafter referred to as a C2a region) than at a region surrounded by an alternate long and two short dashes line indicated by C2b (hereinafter referred to as a C2b region).

In this manner, on the battery surface, on the left-hand side of FIG. 2, the C1a region on the upstream side in the air flow direction has a lower temperature than the downstream C2b region. Accordingly, a heat transfer is caused in a direction indicated by a white arrow, so that a temperature difference between the C1a region and the C2b region is limited. On the right-hand side of FIG. 2, the C2a region on the upstream side in the air flow direction has a lower temperature than the downstream C1b region. Accordingly, a heat transfer due to heat conduction is caused in a direction indicated by a white arrow, so that a temperature difference between the C2a region and the C1b region is limited. Therefore, a remarkable temperature distribution of the temperature of the battery surface on the passage formation surface 20c of the battery is resolved because of the limitation of the temperature difference between the regions.

As illustrated in FIG. 3, at the time of warming the battery, the air which has been blown through the first branch passage 4 and the inside of the inflow side duct 40 by the blower 3 flows into each of the first inter-battery passages 21 first to release heat at the inlet side part of the first inter-battery passage 21, thereby heating the battery surface. Then, the air flows through the first inter-battery passage 21, in contact with the passage formation surface 20c of the battery, to continue to give the heat to the battery surface, and lastly gives the heat to the battery surface at the outlet side part of the first inter-battery passage 21. Meanwhile, the amount of heat given by the air to the battery surface becomes smaller from the inlet side part toward the outlet side part of the passage. Accordingly, at the time of warming the battery, a heating effect is greater at a region closer to the inlet part of the first inter-battery passage 21, and the heating effect is further reduced at a region closer to the outlet part of the passage 21. Thus, in FIG. 3, the effect of heating the battery surface is greater at a region surrounded by an alternate long and two short dashes line indicated by H1a (hereinafter referred to as an H1a region) than at a region surrounded by an alternate long and two short dashes line indicated by H1b (hereinafter referred to as an H1b region).

On the other hand, at the time of warming the battery, the air which has been blown through the second branch passage 5 and the inside of the inflow side duct 50 by the blower 3 flows into each of the second inter-battery passages 22 first to release heat at the inlet side part of the second inter-battery passage 22, thereby heating the battery surface. Then, the air flows through the second inter-battery passage 22, in contact with the passage formation surface 20c of the battery, to continue to give the heat to the battery surface, and lastly gives the heat to the battery surface at the outlet side part of the second inter-battery passage 22. Meanwhile, the amount of heat given by the air to the battery surface becomes smaller from the inlet side part toward the outlet side part of the passage. Accordingly, at the time of warming the battery, a heating effect is greater at a region closer to the inlet part of the second inter-battery passage 22, and the heating effect is further reduced at a region closer to the outlet part of the passage 22. Thus, in FIG. 3, the effect of heating the battery surface is greater at a region surrounded by an alternate long and two short dashes line indicated by H2a (hereinafter referred to as an H2a region) than at a region surrounded by an alternate long and two short dashes line indicated by H2b (hereinafter referred to as an H2b region).

In this manner, on the battery surface, on the left-hand side of FIG. 3, the H2b region on the downstream side in the air flow direction has a lower temperature than the upstream H1a region. Accordingly, a heat transfer is caused in a direction indicated by a white arrow, so that a temperature difference between the H2b region and the H1a region is limited. On the right-hand side of FIG. 3, the H1b region on the downstream side in the air flow direction has a lower temperature than the upstream H2a region. Accordingly, a heat transfer due to heat conduction is caused in a direction indicated by a white arrow, so that a temperature difference between the H1b region and the H2a region is limited. Therefore, a remarkable temperature distribution of the temperature of the battery surface on the passage formation surface 20c of the battery is resolved because of the limitation of the temperature difference between the regions.

FIG. 11 is a schematic view illustrating a temperature distribution that can be caused on a battery surface due to the air flow in accordance with a conventional example. As in the conventional example illustrated in FIG. 11, when air flows into an inter-battery passage in a direction (horizontal direction) perpendicular to a projecting direction of an electrode terminal 200a, the temperature distribution on the surface of a battery 200 has the following tendencies at the time of warming the battery and at the time of cooling the battery.

At the time of cooling the battery, a cooling effect is greater on the upstream side in an air flow direction. Accordingly, a portion of the surface of the battery 200 corresponding to the upstream side in the air flow direction (region surrounded by an alternate long and two short dashes line indicated by Za on a left-hand side in FIG. 11) has a low temperature. Conversely, a portion corresponding to a downstream side of this upstream side portion (region surrounded by an alternate long and two short dashes line indicated by Zb on a right-hand side in FIG. 11) has a high temperature. In this manner, at the time of cooling the battery, on a passage formation surface 200c of the battery, a remarkable temperature distribution is caused due to a temperature difference between the low temperature region Za on the upstream side in the air flow direction and the high temperature region Zb on the downstream side. The low temperature region Za and the high temperature region Zb correspond respectively to the upstream and downstream sides in the air flow direction. Consequently, they are not closely positioned to each other but distantly-positioned to some extent from each other because of the formation of the air passage. Thus, a heat transfer due to heat conduction does not sufficiently occur between the low temperature region Za and the high temperature regions Zb. As a result, the temperature difference cannot be eliminated as in the present embodiment, and a large temperature difference is thereby made on the battery surface.

On the other hand, at the time of warming the battery, a heating effect is greater on the upstream side in an air flow direction. Accordingly, a portion of the surface of the battery 200 corresponding to the upstream side in the air flow direction (region surrounded by an alternate long and two short dashes line indicated by Za on a left-hand side in FIG. 11) has a high temperature. Conversely, a portion corresponding to a downstream side of this upstream side portion (region surrounded by an alternate long and two short dashes line indicated by Zb on a right-hand side in FIG. 11) has a low temperature. At the time of warming the battery as well, similar to the above-described time of cooling the battery, a heat transfer due to heat conduction does not sufficiently occur between the high temperature region Za and the low temperature regions Zb. As a result, the temperature difference cannot be eliminated as in the present embodiment, and a large temperature difference is thereby made on the battery surface.

As described above, in the conventional example shown as a comparative example in FIG. 11, a remarkable temperature distribution, which becomes an issue, is caused in temperature of the battery surface both at the time of cooling the battery and at the time of warming the battery. This temperature distribution is a factor in preventing proper battery temperature management. Accordingly, the battery temperature regulating device 1 of the present embodiment includes the following characteristics that solve this issue.

In the present embodiment, the battery temperature regulating device 1 includes the batteries 20 connected to be capable of energization and stacked, the inter-battery passages divided from each other between the adjacent batteries, and the blower 3 that makes the temperature regulating fluid (e.g., air) for regulating the temperature of the battery 20 flow through the inter-battery passages. The inter-battery passages include the first inter-battery passage 21 and second inter-battery passage 22 into which the temperature regulating fluid flows in different directions between the batteries. A direction of a flow of the temperature regulating fluid flowing through the first inter-battery passage 21 is opposite from a direction of a flow of the temperature regulating fluid flowing through the second inter-battery passage 22.

Accordingly, the first inter-battery passage 21 and second inter-battery passage 22 into which their respective temperature regulating fluids flows in opposite directions are provided for the inter-battery passages of the stacked batteries 20. As a result, the temperature regulating fluids flowing through their respective inter-battery passages have a great temperature regulating effect on the battery surfaces located at their inflow regions. This great temperature regulating effect cannot be exerted on the battery surfaces located at their outflow regions.

On a surface of the battery 20, there are caused at least two regions which receive a great temperature regulating effect and two regions which receive a decreased temperature regulating effect, and temperature differences because of this are made. In this manner, the battery temperature regulating device 1 can make the temperature differences at many positions on the surface of the battery 20 in comparison with the conventional example in which the temperature regulating fluid flows through the inter-battery passage only in one direction. For this reason, heat conductions due to the temperature differences can be actively caused on the surface of the battery 20. By this increase in the number of positions of heat conduction, the heat transfers on the surface of the battery 20 are promoted. As a result, the temperature difference on the surface of the battery 20 can be limited. Moreover, as described above, there is obtained the battery temperature regulating device 1 that can limit creation of a great temperature difference on the surface of the battery 20 both at the times of warming and cooling the battery.

Furthermore, in the battery temperature regulating device 1 of the present embodiment, the first inter-battery passage 21 is a passage through which air flows in one direction on one side (upper half side) of the passage formation surface 20c of the battery and flows out of between the batteries. The second inter-battery passage 22 is a passage which is located on the other side (lower half side) of the passage formation surface 20c of the battery adjacent to the first inter-battery passage 21 and through which air flows in the opposite direction from a direction of the air flowing through the first inter-battery passage 21.

As a result of this configuration, the surface portions of the battery 20 that receive a great temperature regulating effect from the air are formed at a position corresponding to the upstream side of the first inter-battery passage 21 in the air flow direction and at a position corresponding to the upstream side of the second inter-battery passage 22 in the air flow direction. The surface portions of the battery 20 that do not receive a great temperature regulating effect from the air are formed at a position corresponding to the downstream side of the first inter-battery passage 21 in the air flow direction and at a position corresponding to the downstream side of the second inter-battery passage 22 in the air flow direction. In addition, the position corresponding to the upstream side of the first inter-battery passage 21 in the air flow direction, and the position corresponding to the downstream side of the second inter-battery passage 22 in the air flow direction are adjacently located, and the position corresponding to the upstream side of the second inter-battery passage 22 in the air flow direction, and the position corresponding to the downstream side of the first inter-battery passage 21 in the air flow direction are adjacently located. Accordingly, on the surface of the battery 20, regions which receive a great temperature regulating effect are produced on one side and on the other side, and regions which receive a reduced temperature regulating effect are produced on the other side and on one side; and the regions receiving a great effect and the regions receiving a reduced effect are adjacently located respectively. Thus, temperature differences due to this are made.

Therefore, on the surface of the battery 20, the battery temperature regulating device 1 can actively give rise to the heat conductions caused by the temperature differences in directions in which the first inter-battery passage 21 and second inter-battery passage 22 are arranged. In this manner, because of the effect of promoting the heat transfers in these directions, the battery temperature regulating device 1 can limit the temperature differences on the surface of the battery 20.

### Second Embodiment

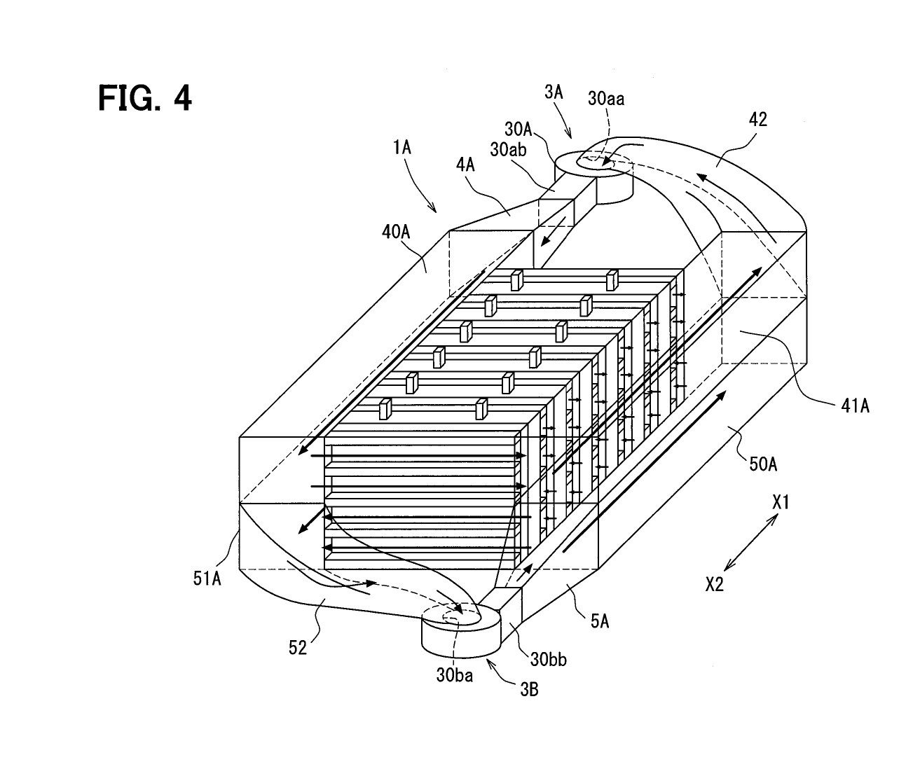

In a second embodiment, a battery temperature regulating device 1A which is another mode of the first embodiment will be described in reference to FIG. 4. FIG. 4 is a perspective view indicating a configuration and an air flow direction of the battery temperature regulating device 1A. In FIG. 4, a component having the same reference numeral as in FIG. 1 is the same component as in FIG. 1, and its operation and effects are similar to FIG. 1. In FIG. 4, the flows of air are indicated by arrows, and a part of a battery 20 that cannot be seen from the outside under ordinary circumstances is indicated by a continuous line to assist in easily understanding passages between batteries. The mode, operation and so forth, which are different from the first embodiment, will be described below. The battery temperature regulating device 1A produces the operation and effects described with reference to FIGS. 2 and 3 in the first embodiment.

The battery temperature regulating device 1A includes a battery group 2, a first circulation passage through which the air flowing through a first inter-battery passage 21 circulates, a blower 3A for driving the air circulating through the first circulation passage, a second circulation passage through which the air flowing through a second inter-battery passage 22 circulates, and a blower 3B for driving the air flowing through the second circulation passage.

The blower 3A includes a sirocco fan, a scroll casing 30A having therein the sirocco fan, and a motor which rotates the sirocco fan. The scroll casing 30A includes a suction port 30aa on its upper surface and a blow-out part 30ab extending in the centrifugal direction. The blower 3A is disposed at a position away from the battery group 2 in a stacking one direction X1 in which the stacked batteries 20 are arranged.

A blow-out duct 4A is connected to the blow-out part 30ab. The blow-out duct 4A is connected to an inflow side duct 40A which is disposed to cover the entire upper half of the lateral part of the battery group 2. The inside of the inflow side duct 40A communicates with the first inter-battery passages 21 arranged at intervals in a stacking one direction X1 at the entire upper half of the lateral part of the battery group 2. The outlet parts of the first inter-battery passages 21 are arranged to be covered with an outflow side duct 41A at the entire upper half of the lateral part of the battery group 2 on the opposite side from the inflow side duct 40A. The end of the outflow side duct 41A located in the stacking one direction X1 and the suction port 30aa of the blower 3A are connected together by a suction duct 42. In this manner, the first circulation passage includes the inside of the blower 3A, the passage in the blow-out duct 4A, the passage in the inflow side duct 40A, the first inter-battery passages 21, the passage in the outflow side duct 41A, and the passage in the suction duct 42.

As a result of the above-described configuration, the air blown out from the blower 3A flows into the inflow side duct 40A through the blow-out duct 4A to flow forward in the inflow side duct 40A in a stacking other direction X2 which is the opposite direction of the stacking one direction X1 and to flow into each of the first inter-battery passages 21. The air exchanges heat with the battery surface when passing through each of the first inter-battery passages 21. The air which has flowed out of the first inter-battery passages 21 proceeds in the stacking one direction X1 through the passage in the outflow side duct 41A and flows down the suction duct 42 to be drawn into the blower 3A. As a result, the air circulates through the first circulation passage.

The blower 3B includes a sirocco fan, a scroll casing 30B having therein the sirocco fan, and a motor which rotates the sirocco fan. The scroll casing 30B includes a suction port 30ba on its upper surface and a blow-out part 30bb extending in the centrifugal direction. The blower 3B is disposed at a position distant from the battery group 2 in the stacking other direction X2. For example, the blower 3A and the blower 3B are arranged at symmetrical positions with respect to the battery group.

A blow-out duct 5A is connected to the blow-out part 30bb. The blow-out duct 5A is connected to an inflow side duct 50A which is disposed to cover the entire lower half of the lateral part of the battery group 2. The inside of the inflow side duct 50A communicates with the second inter-battery passages 22 arranged at intervals in a stacking one direction X1 at the entire lower half of the lateral part of the battery group 2. The outlet parts of the second inter-battery passages 22 are arranged to be covered with an outflow side duct 51A at the entire lower half of the lateral part of the battery group 2 on the opposite side from the inflow side duct 50A. The end of the outflow side duct 51A located in the stacking other direction X2 and the suction port 30ba of the blower 3B are connected together by a suction duct 52. In this manner, the second circulation passage includes the inside of the blower 3B, the passage in the blow-out duct 5A, the passage in the inflow side duct 50A, the second inter-battery passages 22, the passage in the outflow side duct 51A, and the passage in the suction duct 52.

As a result of the above-described configuration, the air blown out from the blower 3B flows into the inflow side duct 50A through the blow-out duct 5A to flow forward in the inflow side duct 50A in the stacking one direction X1 and to flow into each of the second inter-battery passages 22. The air exchanges heat with the battery surface when passing through each of the second inter-battery passages 22. The air which has flowed out of the second inter-battery passages 22 proceeds in the stacking other direction X2 through the passage in the outflow side duct 51A and flows down the suction duct 52 to be drawn into the blower 3B. As a result, the air circulates through the second circulation passage.

### Third Embodiment

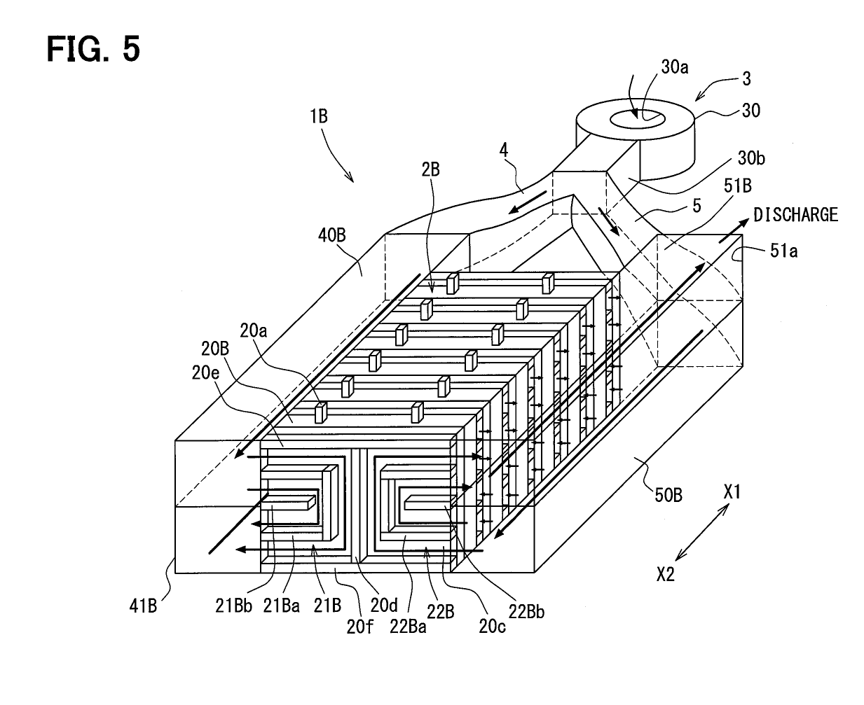

In a third embodiment, a battery temperature regulating device 1B which is another mode of the first embodiment will be described in reference to FIGS. 5 to 7. FIG. 5 is a perspective view indicating a configuration and an air flow direction of the battery temperature regulating device 1B. In FIG. 5, the flows of air are indicated by arrows, and a part of a battery 20B that cannot be seen from the outside under ordinary circumstances is indicated by a continuous line to assist in easily understanding passages between batteries. In FIG. 5, a component having the same reference numeral as in FIG. 1 is the same component as in FIG. 1, and its operation and effects are similar to FIG. 1. The mode, operation and so forth, which are different from the first embodiment, will be described below.

The battery temperature regulating device 1B includes a battery group 2B having batteries 20B connected to be capable of energization, and a blower 3 which blows air through the passages between the batteries. Each of the passages between the batteries includes a first inter-battery passage 21B and a second inter-battery passage 22B. The first inter-battery passage 21B and second inter-battery passage 22B are arranged to be left-right symmetrical on a passage formation surface 20c of the battery. The first inter-battery passage 21B is a passage defining a flow route through which the inflow air flows back at a halfway portion of a passage between the batteries 20B to flow out of the passage between the batteries 20B in the opposite direction from its inflow direction. The second inter-battery passage 22B is a passage defining a flow route through which the air flows into the battery group 2B in the opposite direction from the direction of the air flowing into the first inter-battery passage 21B and flows back at a halfway portion of a passage between the batteries 20B to flow reversely out of the passage between the batteries 20B.

The battery 20B includes on a left half of its surface opposed to its adjacent battery 20B, a horseshoe-shaped rib 21Ba that connects together a portion extending in a horizontal direction perpendicular to a projecting direction of an electrode terminal 20a, a portion extending in the vertical direction, and a portion extending in the horizontal direction; a rib 21Bb dividing the inside of the rib 21Ba between upper and lower parts; and a rib 20e, a rib 20f extending from side to side at both upper and lower ends of the battery 20B. Furthermore, the battery 20B includes on a right half of its surface opposed to its adjacent battery 20B, a horseshoe-shaped rib 22Ba and a rib 22Bb which are symmetrical to the rib 21Ba and the rib 21Bb provided on the left half. A rib 20d traversing on the passage formation surface 20c of the battery in the vertical direction is provided between the rib 21Ba and the rib 21Bb on the left-hand side, and the rib 22Ba and the rib 22Bb on the right-hand side.

The first inter-battery passage 21B includes on a left half of the passage formation surface 20c of the battery, a horseshoe-shaped inner passage formed between the rib 21Ba and the rib 21Bb, and a horseshoe-shaped outer passage located outward of this inner passage and formed between the rib 20e, the rib 20f, the rib 20d, and the rib 21Ba. Between the batteries 20B, the air flowing through the first inter-battery passage 21B flows into the battery group 2B from an upper left part, and turns around to flow out from a lower left part. Between the batteries 20B, the air flowing through the second inter-battery passage 22B flows into the battery group 2B from an lower right part, and turns around to flow out from a upper right part. In this manner, the part of the first inter-battery passage 21B into which the air flows, and the part of the second inter-battery passage 22B into which the air flows are arranged diagonally on the passage formation surface 20c of the battery.

A first branch passage 4 is connected to an inflow side duct 40B which is disposed to cover the entire upper half of the left lateral part of the battery group 2B. The inside of the inflow side duct 40B communicates with the first inter-battery passages 21B arranged at intervals in a stacking one direction X1 at the entire upper half of the left lateral part of the battery group 2B. The outlet parts of the first inter-battery passages 21B are arranged to be covered with an outflow side duct 41B under the inflow side duct 40B at the entire lower half of the left lateral part of the battery group 2B. A discharge port (not shown) through which the air flowing out of the first inter-battery passages 21B is discharged into the outside opens at the end of the outflow side duct 41B located in the stacking one direction X1.

As a result of the above-described configuration, the air drawn into the suction port 30a by the blower 3 branches in two directions at the two-way duct part and flows into the inflow side duct 40B from the one (first) branch passage 4 to flow forward in the inflow side duct 40B in a stacking other direction X2 and also to flow into each of the first inter-battery passages 21B. The air which has turned around between the batteries 20B and flowed out of the first inter-battery passages 21B flows forward through the passage in the outflow side duct 41B in the stacking one direction X1 and is discharged into the outside through the discharge port.

The second branch passage 5 is connected to the inflow side duct 50B that is disposed to cover the entire lower half of the right lateral part of the battery group 2B. The passage in the inflow side duct 50B communicates with the second inter-battery passages 22B that are arranged at intervals in the stacking one direction X1 at the entire lower half of the right lateral part of the battery group 2B. The outlet parts of the second inter-battery passages 22B are arranged to be covered with an outflow side duct 51B above the inflow side duct 50B at the entire upper half of the right lateral part of the battery group 2B. A discharge port 51a through which the air flowing out of the second inter-battery passages 22B is discharged into the outside opens at the end of the outflow side duct 51B located in the stacking one direction X1.

As a result of the above-described configuration, the air drawn into the suction port 30a by the blower 3 flows into the inflow side duct 50B from the other (second) branch passage 5 at the two-way duct part to flow forward in the inflow side duct 50B in the stacking other direction X2 and also to flow into each of the second inter-battery passages 22B. The air which has turned around between the batteries 20B and flowed out of the second inter-battery passages 22B flows forward in the outflow side duct 51B in the stacking one direction X1 and is discharged into the outside through the discharge port 51a. As described above, there are formed air flows whose directions are opposite from each other along an air flow route running through the first inter-battery passages 21B formed at the left half of the battery group 2B, and along an air flow route running through the second inter-battery passages 22B formed at the right half of the battery group 2B.

When restraining force in the stacking direction is applied to each battery 20B by a restraint device, each of the rib 21Ba and the rib 21Bb located at the left half, the rib 22Ba and the rib 22Bb located at the right half, the central rib 20d, and the rib 20e and the rib 20f at the upper and lower ends is brought into contact with the passage formation surface 20c of the adjacent battery, and receives the force applied from this adjacent battery 20B. These ribs have strength that receives the force in a compression direction by the restraining force when in contact with the passage formation surface 20c of the adjacent battery. In addition, these ribs have a function that can increase a heat transmission area of the battery 20B.

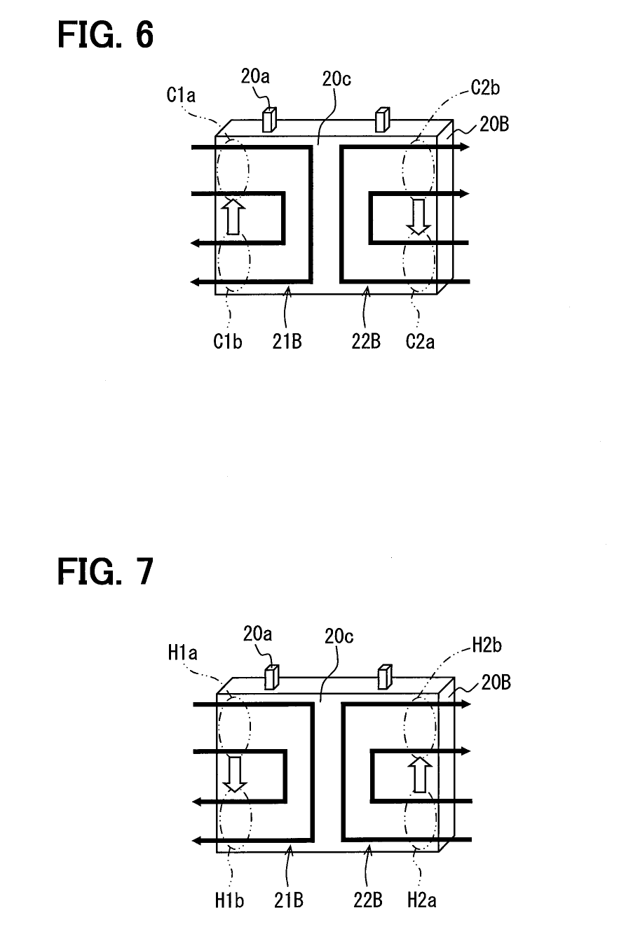

The air flowing at the same time through the first inter-battery passage 21B and second inter-battery passage 22B by the blower 3 warms each battery 20B if the air is supplied to both the passages after being heated by a heating element such as an electric heater or a heat exchanger. On the other hand, the air cools each battery 20B if the air is supplied to both the passages without particularly being heated. FIG. 6 is a schematic view illustrating a direction of air and a direction of heat conduction relative to the battery 20B at the time of cooling the battery. FIG. 7 is a schematic view illustrating an air flow direction and a direction of heat conduction relative to the battery 20B at the time of warming the battery.

As illustrated in FIG. 6, at the time of cooling the battery, the air blown through the first branch passage 4 and the inside of the inflow side duct 40B by the blower 3 flows into each of the horseshoe-shaped first inter-battery passages 21B arranged on the left half side of the battery group 2B first to remove the heat of the battery surface at the inlet side part of the first inter-battery passage 21B, thereby cooling the battery. Then, the air flows in a U-turn manner through the first inter-battery passage 21B in contact with the passage formation surface 20c of the battery to continue to remove the heat of the battery surface and lastly to remove the heat of the battery surface at the outlet side part of the first inter-battery passage 21B. Meanwhile, the amount of heat absorbed by the air from the battery surface becomes smaller from the inlet side part toward the outlet side part of the passage. Accordingly, at the time of cooling the battery, a cooling effect is greater at a region closer to the inlet part of the first inter-battery passage 21B, and the cooling effect is further reduced at a region closer to the outlet part of the passage 21B. Thus, in FIG. 6, the effect of cooling the battery surface is greater at a region surrounded by an alternate long and two short dashes line indicated by C1a (hereinafter referred to as a C1a region) than at a region surrounded by an alternate long and two short dashes line indicated by C1b (hereinafter referred to as a C1b region).

On the other hand, at the time of cooling the battery, the air blown through the second branch passage 5 and the inside of the inflow side duct 50B by the blower 3 flows into each of the second inter-battery passages 22B arranged on the right half side of the battery group 2B first to remove the heat of the battery surface at the inlet side part of the second inter-battery passage 22B, thereby cooling the battery. Then, the air flows in a U-turn manner through the second inter-battery passage 22B in contact with the passage formation surface 20c of the battery to continue to remove the heat of the battery surface and lastly to remove the heat of the battery surface at the outlet side part of the second inter-battery passage 22B. Meanwhile, the amount of heat absorbed by the air from the battery surface becomes smaller from the inlet side part toward the outlet side part of the passage. Accordingly, at the time of cooling the battery, a cooling effect is greater at a region closer to the inlet part of the second inter-battery passage 22B, and the cooling effect is further reduced at a region closer to the outlet part of the passage 22B. Thus, in FIG. 6, the effect of cooling the battery surface is greater at a region surrounded by an alternate long and two short dashes line indicated by C2a (hereinafter referred to as a C2a region) than at a region surrounded by an alternate long and two short dashes line indicated by C2b (hereinafter referred to as a C2b region).

In this manner, on the battery surface, on the left-hand side of FIG. 6, the C1a region on the upstream side in the air flow direction has a lower temperature than the downstream C1b region. Accordingly, a heat transfer is caused in a direction indicated by a white arrow, so that a temperature difference between the C1a region and the C1b region is limited. On the right-hand side of FIG. 6, the C2a region on the upstream side in the air flow direction has a lower temperature than the downstream C2b region. Accordingly, a heat transfer due to heat conduction is caused in a direction indicated by a white arrow, so that a temperature difference between the C2a region and the C2b region is limited. Therefore, a remarkable temperature distribution of the temperature of the battery surface on the passage formation surface 20c of the battery is resolved because of the limitation of the temperature difference between the regions.

As illustrated in FIG. 7, at the time of warming the battery, the air which has been blown through the first branch passage 4 and the inside of the inflow side duct 40B by the blower 3 flows into each of the first inter-battery passages 21B first to release heat at the inlet side part of the first inter-battery passage 21B, thereby heating the battery surface. Then, the air flows in a U-turn manner through the first inter-battery passage 21B in contact with the passage formation surface 20c of the battery to continue to give the heat to the battery surface and lastly to give the heat to the battery surface at the outlet side part of the first inter-battery passage 21B. Meanwhile, the amount of heat given by the air to the battery surface becomes smaller from the inlet side part toward the outlet side part of the passage. Accordingly, at the time of warming the battery, a heating effect is greater at a region closer to the inlet part of the first inter-battery passage 21B, and the heating effect is further reduced at a region closer to the outlet part of the passage 21B. Thus, in FIG. 7, the effect of heating the battery surface is greater at a region surrounded by an alternate long and two short dashes line indicated by H1a (hereinafter referred to as a H1a region) than at a region surrounded by an alternate long and two short dashes line indicated by H1b (hereinafter referred to as a H1b region).

On the other hand, at the time of warming the battery, the air which has been blown through the second branch passage 5 and the inside of the inflow side duct 50B by the blower 3 flows into each of the second inter-battery passages 22B first to release heat at the inlet side part of the second inter-battery passage 22B, thereby heating the battery surface. Then, the air flows in a U-turn manner through the second inter-battery passage 22B in contact with the passage formation surface 20c of the battery to continue to give the heat to the battery surface and lastly to give the heat to the battery surface at the outlet side part of the second inter-battery passage 22B. Meanwhile, the amount of heat given by the air to the battery surface becomes smaller from the inlet side part toward the outlet side part of the passage. Accordingly, at the time of warming the battery, a heating effect is greater at a region closer to the inlet part of the second inter-battery passage 22B, and the heating effect is further reduced at a region closer to the outlet part of the passage 22B. Thus, in FIG. 7, the effect of heating the battery surface is greater at a region surrounded by an alternate long and two short dashes line indicated by H2a (hereinafter referred to as a H2a region) than at a region surrounded by an alternate long and two short dashes line indicated by H2b (hereinafter referred to as a H2b region).

In this manner, on the battery surface, on the left-hand side of FIG. 7, the H1b region on the downstream side in the air flow direction has a lower temperature than the upstream H1a region. Accordingly, a heat transfer is caused in a direction indicated by a white arrow, so that a temperature difference between the H1b region and the H1a region is limited. On the right-hand side of FIG. 7, the H2b region on the downstream side in the air flow direction has a lower temperature than the upstream H2a region. Accordingly, a heat transfer due to heat conduction is caused in a direction indicated by a white arrow, so that a temperature difference between the H2b region and the H2a region is limited. Therefore, a remarkable temperature distribution of the temperature of the battery surface on the passage formation surface 20c of the battery is resolved because of the limitation of the temperature difference between the regions.

In the battery temperature regulating device 1B of the present embodiment, the first inter-battery passage 21B is a passage defining a flow route through which the inflow air flows back at a halfway portion of a passage between the batteries 20B to flow out of the passage between the batteries 20B in the opposite direction from its inflow direction. The second inter-battery passage 22B is a passage defining a flow route through which the air flows into the battery group 2B in the opposite direction from the direction of the air flowing into the first inter-battery passage 21B and flows back at a halfway portion of a passage between the batteries 20B to flow reversely out of the passage between the batteries 20B.

As a result of this configuration, on the surface of the battery 20B, a region receiving a great temperature regulating effect, and a region receiving a reduced temperature regulating effect are produced adjacently at the air inflow part and the air outflow part of the first inter-battery passage 21B respectively so that a temperature difference is made; and a region receiving a great temperature regulating effect, and a region receiving a reduced temperature regulating effect are produced adjacently at the air inflow part and the air outflow part of the second inter-battery passage 22B respectively so that a temperature difference is made. Accordingly, on the surface of each battery 20B, the battery temperature regulating device 1B can actively cause the heat conductions due to the temperature differences respectively between the U-turn shaped passages of the first inter-battery passages 21B and between the U-turn shaped passages of the second inter-battery passages 22B. Because of the effect of promoting the heat transfers in these directions, there can be provided the battery temperature regulating device 1B that can limit the temperature difference on the surface of each battery 20B.

In addition, the part of the first inter-battery passage 21B into which the air flows, and the part of the second inter-battery passage 22B into which the air flows are arranged diagonally on the passage formation surface 20c of the battery.

As a result of this configuration, on the surface of the battery 20B, in addition to the heat conduction due to a temperature difference caused as described above, heat conduction due to a temperature difference can actively be caused also between the turn-back part of the first inter-battery passage 21B and the turn-back part of the second inter-battery passage 22B, which are adjacently located. Therefore, the number of positions, where heat transfer is promoted, can be further increased on the surface of each battery 20B. Consequently, there can be provided the battery temperature regulating device 1B that can further improve the effect of limiting the temperature difference on the surface of the battery 20B.

### Fourth Embodiment

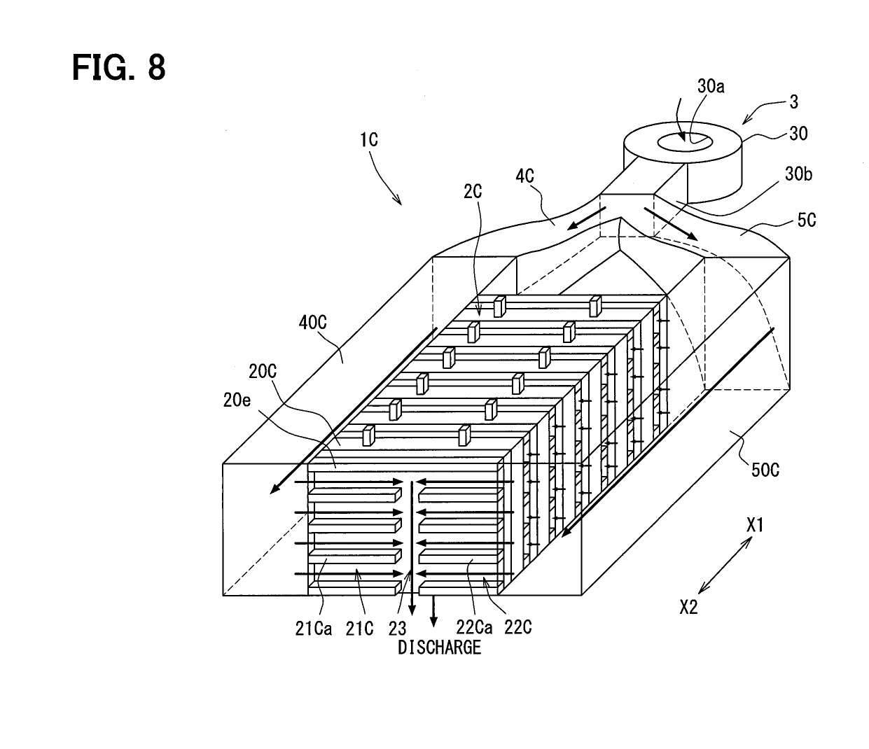

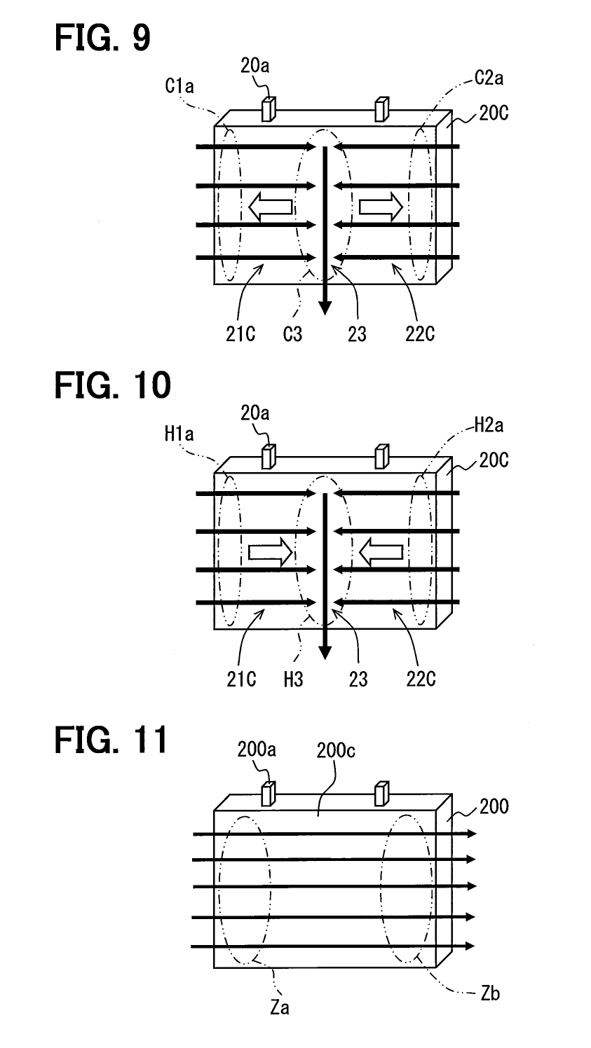

In a fourth embodiment, a battery temperature regulating device 1C which is another mode of the first embodiment will be described in reference to FIGS. 8 and 9. FIG. 8 is a perspective view indicating a configuration and an air flow direction of the battery temperature regulating device 1C. In FIG. 8, the flows of air are indicated by arrows, and a part of a battery 20C that cannot be seen from the outside under ordinary circumstances is indicated by a continuous line to assist in easily understanding passages between batteries. In FIG. 8, a component having the same reference numeral as in FIG. 1 is the same component as in FIG. 1, and its operation and effects are similar to FIG. 1. The mode, operation and so forth, which are different from the first embodiment, will be described below.

The battery temperature regulating device 1C includes a battery group 2C having batteries 20C connected to be capable of energization, and a blower 3 which blows air through the passages between the batteries. Each of the passages between the batteries includes a first inter-battery passage 21C and a second inter-battery passage 22C. The first inter-battery passage 21C and second inter-battery passage 22C are arranged to be left-right symmetrical on a passage formation surface 20c of the battery. The first inter-battery passage 21C is a passage extending from one side (left half side) toward the central part of the passage formation surface 20c of the battery. The second inter-battery passage 22C is a passage extending from the other side (right half side) toward the central part of the passage formation surface 20c of the battery.

A third inter-battery passage 23 extending in the vertical direction is provided at the central part of the passage formation surface 20c of the battery. The airs which have flowed respectively through the first inter-battery passage 21C and the second inter-battery passage 22C merge together to flow down along the third inter-battery passage 23. A direction in which the air flows into the second inter-battery passage 22C is an opposite direction from a direction in which the air flows into the first inter-battery passage 21C.

The battery 20C includes ribs 21Ca extending in the horizontal direction perpendicular to a projecting direction of an electrode terminal 20a and arranged at intervals in this projecting direction on a left half of a surface opposed to its adjacent battery 20C, ribs 22Ca which are provided symmetrically to the ribs 21Ca on a right half, and a rib 20e extending from side to side at its upper end. Passages between the ribs 21Ca constitute the first inter-battery passage 21C, and passages between the ribs 22Ca constitute the second inter-battery passage 22C. Predetermined clearances are formed between the ribs 21Ca and the ribs 22Ca, and these correspond to the third inter-battery passage 23 extending in the vertical direction. When the air flows up the third inter-battery passage 23, it reaches the rib 20e, and when the air flows down, there is no covering member and the lower part of the passage 23 is open. This lower end part of the third inter-battery passage 23 corresponds to a discharge port of air.

A first branch passage 4C is connected to an inflow side duct 40C that is disposed to cover the entire left lateral part of the battery group 2C. The inside of the inflow side duct 40C communicates with the first inter-battery passages 21C arranged at intervals in a stacking one direction X1 at the entire left lateral part of the battery group 2C. The outlet parts of the first inter-battery passages 21C are connected to the third inter-battery passage 23 between the batteries 20C.

As a result of the above-described configuration, the air drawn into the suction port 30a by the blower 3 branches in two directions at the two-way duct part and flows into the inflow side duct 40C from the one (first) branch passage 4C to flow forward in the inflow side duct 40C in a stacking other direction X2 and also to flow into each of the first inter-battery passages 21C. The air flowing out of the first inter-battery passages 21C merges with the air flowing out of the second inter-battery passages 22C at the third inter-battery passage 23 to be discharged into the outside from the central part of a lower end of the battery group 2C.

The second branch passage 5C is connected to the inflow side duct 50C that is disposed to cover the entire right lateral part of the battery group 2C. The passage in the inflow side duct 50C communicates with the second inter-battery passages 22C that are arranged at intervals in the stacking one direction X1 at the entire right lateral part of the battery group 2C. The outlet parts of the second inter-battery passages 22C are connected to the third inter-battery passage 23 between the batteries 20C.

As a result of the above-described configuration, the air drawn into the suction port 30a by the blower 3 flows into the inflow side duct 50C from the other (second) branch passage 5C at the two-way duct part to flow forward in the inflow side duct 50C in a stacking other direction X2 and also to flow into each of the second inter-battery passages 22C. The air flowing out of the second inter-battery passages 22C merges with the air flowing out of the first inter-battery passages 21C at the third inter-battery passage 23 to be discharged into the outside from the central part of a lower end of the battery group 2C. As described above, there are formed air flows whose directions are opposite from each other along an air flow route running through the first inter-battery passages 21C formed at the left half of the battery group 2C, and along an air flow route running through the second inter-battery passages 22C formed at the right half of the battery group 2C.

When the restraining force in the stacking direction is applied to the batteries 20C by the restraint device, the ribs 21Ca located on the left half and the ribs 22Ca located on the right half are respectively in contact with the passage formation surface 20c of the adjacent battery to receive the force applied from this adjacent battery 20C. These ribs have strength that receives the force in a compression direction by the restraining force when in contact with the passage formation surface 20c of the adjacent battery. In addition, these ribs have a function that can increase a heat transmission area of the battery 20C.

The air flowing at the same time through the first inter-battery passage 21C and second inter-battery passage 22C by the blower 3 warms each battery 20C if the air is supplied to both the passages after being heated by a heating element such as an electric heater or a heat exchanger. On the other hand, the air cools each battery 20C if the air is supplied to both the passages without particularly being heated. FIG. 9 is a schematic view illustrating a direction of air and a direction of heat conduction relative to the battery 20C at the time of cooling the battery. FIG. 10 is a schematic view illustrating an air flow direction and a direction of heat conduction relative to the battery 20C at the time of warming the battery.

As illustrated in FIG. 9, at the time of cooling the battery, the air blown through the first branch passage 4C and the inside of the inflow side duct 40C by the blower 3 flows into each of the first inter-battery passages 21C arranged on the left half side of the battery group 2C first to remove the heat of the battery surface at the inlet side part of the first inter-battery passage 21, thereby cooling the battery. Then, the air flows through the first inter-battery passage 21C, in contact with the passage formation surface 20c of the battery, to continue to remove the heat of the battery surface, and lastly removes the heat of the battery surface at the outlet side part of the first inter-battery passage 21C. Meanwhile, the amount of heat absorbed by the air from the battery surface becomes smaller from the inlet side part toward the outlet side part of the passage. Accordingly, at the time of cooling the battery, a cooling effect is greater at a region closer to the inlet part of the first inter-battery passage 21C, and the cooling effect is further reduced at a region closer to the outlet part of the passage 21C. Thus, in FIG. 9, the effect of cooling the battery surface is greater at a region surrounded by an alternate long and two short dashes line indicated by C1a (hereinafter referred to as a C1a region) than at a region surrounded by an alternate long and two short dashes line indicated by C3 (hereinafter referred to as a C3 region).

On the other hand, at the time of cooling the battery, the air blown through the second branch passage 5C and the inside of the inflow side duct 50C by the blower 3 flows into each of the second inter-battery passages 22C arranged on the right half side of the battery group 2C first to remove the heat of the battery surface at the inlet side part of the second inter-battery passage 22C, thereby cooling the battery. Then, the air flows through the second inter-battery passage 22C, in contact with the passage formation surface 20c of the battery, to continue to remove the heat of the battery surface, and lastly removes the heat of the battery surface at the outlet side part of the second inter-battery passage 22C. Meanwhile, the amount of heat absorbed by the air from the battery surface becomes smaller from the inlet side part toward the outlet side part of the passage. Accordingly, at the time of cooling the battery, a cooling effect is greater at a region closer to the inlet part of the second inter-battery passage 22C, and the cooling effect is further reduced at a region closer to the outlet part of the passage 22C. Thus, in FIG. 9, the effect of cooling the battery surface is greater at a region surrounded by an alternate long and two short dashes line indicated by C2a (hereinafter referred to as a C2a region) than at a region surrounded by an alternate long and two short dashes line indicated by C3 (hereinafter referred to as a C3 region).

In this manner, on the battery surface, on the left-hand side of FIG. 9, the C1 a region on the upstream side in the air flow direction has a lower temperature than the downstream C3 region. Accordingly, a heat transfer is caused in a direction indicated by a white arrow, so that a temperature difference between the C1a region and the C3 region is limited. On the right-hand side of FIG. 9, the C2a region on the upstream side in the air flow direction has a lower temperature than the downstream C3 region. Accordingly, a heat transfer due to heat conduction is caused in a direction indicated by a white arrow, so that a temperature difference between the C2a region and the C3 region is limited. Therefore, a remarkable temperature distribution of the temperature of the battery surface on the passage formation surface 20c of the battery is resolved because of the limitation of the temperature difference between the regions.

As illustrated in FIG. 10, at the time of warming the battery, the air which has been blown through the first branch passage 4C and the inside of the inflow side duct 40C by the blower 3 flows into each of the first inter-battery passages 21C first to release heat at the inlet side part of the first inter-battery passage 21C, thereby heating the battery surface. Then, the air flows through the first inter-battery passage 21C, in contact with the passage formation surface 20c of the battery, to continue to give the heat to the battery surface, and lastly gives the heat to the battery surface at the outlet side part of the first inter-battery passage 21C. Meanwhile, the amount of heat given by the air to the battery surface becomes smaller from the inlet side part toward the outlet side part of the passage. Accordingly, at the time of warming the battery, a heating effect is greater at a region closer to the inlet part of the first inter-battery passage 21C, and the heating effect is further reduced at a region closer to the outlet part of the passage 21C. Thus, in FIG. 10, the effect of heating the battery surface is greater at a region surrounded by an alternate long and two short dashes line indicated by H1a (hereinafter referred to as a H1a region) than at a region surrounded by an alternate long and two short dashes line indicated by H3 (hereinafter referred to as a H3 region).

On the other hand, at the time of warming the battery, the air which has been blown through the second branch passage 5C and the inside of the inflow side duct 50C by the blower 3 flows into each of the second inter-battery passages 22C first to release heat at the inlet side part of the second inter-battery passage 22C, thereby heating the battery surface. Then, the air flows through the second inter-battery passage 22C, in contact with the passage formation surface 20c of the battery, to continue to give the heat to the battery surface, and lastly gives the heat to the battery surface at the outlet side part of the second inter-battery passage 22C. Meanwhile, the amount of heat given by the air to the battery surface becomes smaller from the inlet side part toward the outlet side part of the passage. Accordingly, at the time of warming the battery, a heating effect is greater at a region closer to the inlet part of the second inter-battery passage 22C, and the heating effect is further reduced at a region closer to the outlet part of the passage 22C. Thus, in FIG. 10, the effect of heating the battery surface is greater at a region surrounded by an alternate long and two short dashes line indicated by H2a (hereinafter referred to as a H2a region) than at a region surrounded by an alternate long and two short dashes line indicated by H3 (hereinafter referred to as a H3 region).

In this manner, on the battery surface, on the left-hand side of FIG. 10, the H3 region on the downstream side in the air flow direction has a lower temperature than the upstream H1a region. Accordingly, a heat transfer is caused in a direction indicated by a white arrow, so that a temperature difference between the H3 region and the H1a region is limited. On the right-hand side of FIG. 10, the H3 region on the downstream side in the air flow direction has a lower temperature than the upstream H2a region. Accordingly, a heat transfer due to heat conduction is caused in a direction indicated by a white arrow, so that a temperature difference between the H3 region and the H2a region is limited. Therefore, a remarkable temperature distribution of the temperature of the battery surface on the passage formation surface 20c of the battery is resolved because of the limitation of the temperature difference between the regions.

In the battery temperature regulating device 1C of the present embodiment, the first inter-battery passage 21C is a passage through which air flows in one direction from one side to the other side on the passage formation surface 20c of the battery. The second inter-battery passage 22C is a passage through which air flows from the other side to one side on the passage formation surface 20c of the battery in the opposite direction from the direction of the air flowing through the first inter-battery passage 21C. Furthermore, the passages between the batteries include the third inter-battery passage 23 along which the airs flowing respectively through the first inter-battery passage 21C and the second inter-battery passage 22C merge together to flow down.

As a result of this configuration, on the surface of the battery 20C, regions receiving a great temperature regulating effect, and regions receiving a reduced temperature regulating effect are produced respectively at the air inflow part of the first inter-battery passage 21C and the merging part of the third inter-battery passage 23; and at the air inflow part of the second inter-battery passage 22C and the merging part of the third inter-battery passage 23, so that temperature differences due to these can be made. Accordingly, on the surface of the battery 20C, the battery temperature regulating device 1C can actively cause the heat conductions due to the temperature differences respectively between one side part and the merging part and between the other side part and the merging part. Because of the effect of promoting the heat transfers in these directions, there can be provided the battery temperature regulating device 1C that can limit the temperature difference on the surface of each battery 20C.

Modifications to the above embodiments will be described. The present disclosure is not by any means limited to the above embodiments, and can be embodied in various modifications without departing from the scope of the present disclosure. The structures of the above embodiments are only illustrated by examples, and the scope of the present disclosure is not limited to the range of these descriptions.

In the above first embodiment, the first inter-battery passage 21 is a passage through which the temperature regulating fluid flows in one direction to traverse one side of the passage formation surface 20c of the battery and flows out from between the batteries. However, the direction in which the first inter-battery passage 21 extends is not limited to the direction illustrated in the drawings. The same holds true for the second inter-battery passage 22. For example, the first inter-battery passage 21 and the second inter-battery passage 22 may be formed to run vertically or may be formed to extend in an oblique direction on the passage formation surface 20c of the battery.

In the above embodiments, the blowers 3, 3A, 3B for driving the air are employed as a fluid driving device. However, the fluid driving device is not limited to these. For example, if liquid is used as a temperature regulating fluid, various kinds of non-positive displacement pumps, positive displacement pumps, special pumps, and so forth can be employed in accordance with the type and drive amount of the temperature regulating fluid.

In the above embodiments, the battery 20, 20B, 20C which constitutes the battery group 2, 2B, 2C includes an exterior case having a shape of a flat rectangular parallelepiped. However, the battery, to which the present disclosure is applicable, is not limited to such a shape. For example, this battery may include a cylindrical exterior case.

In the above embodiments, the electrode terminal 20a of the battery 20 projects upward on the upper end surface of the battery 20. However, the projecting direction of the electrode terminal 20a, to which the present disclosure is applicable, is not limited to the upward projection. For example, the battery group 2 may be arranged in a state where the projecting direction of the electrode terminal 20a is any one of a downward direction, a horizontal direction, an obliquely upward direction, and an obliquely downward direction.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A battery temperature regulating device comprising:
a plurality of batteries connected to be capable of energization and arranged in a stacking manner;
a plurality of inter-battery passages each of which is defined between corresponding adjacent two of the plurality of batteries; and
a fluid driving device that is configured to flow temperature regulating fluid for regulating temperature of the plurality of batteries through the plurality of inter-battery passages, wherein:
each of the plurality of inter-battery passages includes a first inter-battery passage and a second inter-battery passage;
between the corresponding adjacent two of the plurality of batteries, a direction in which temperature regulating fluid flows into the first inter-battery passage and a direction in which temperature regulating fluid flows into the second inter-battery passage are different from each other; and
a flow direction of temperature regulating fluid flowing through the first inter-battery passage is opposite from a flow direction of temperature regulating fluid flowing through the second inter-battery passage.

2. The battery temperature regulating device according to claim 1, wherein:
the first inter-battery passage is a passage through which temperature regulating fluid flows in one direction on one side of a passage formation surface of one of the corresponding adjacent two of the plurality of batteries and flows out of between the corresponding adjacent two of the plurality of batteries; and
the second inter-battery passage is a passage which is arranged on the other side of the passage formation surface of one of the corresponding adjacent two of the plurality of batteries that is adjacent to the first inter-battery passage and through which temperature regulating fluid flows in an opposite direction from a direction of temperature regulating fluid flowing through the first inter-battery passage.

3. The battery temperature regulating device according to claim 1, wherein:
the first inter-battery passage is a passage defining a flow route through which temperature regulating fluid flows in, flows back at a certain position between the corresponding adjacent two of the plurality of batteries, and flows out of between the corresponding adjacent two of the plurality of batteries in an opposite direction from an inflow direction of temperature regulating fluid; and
the second inter-battery passage is a passage defining a flow route through which temperature regulating fluid flows in, in an opposite direction from a direction of the flow of temperature regulating fluid into the first inter-battery passage, flows back at a certain position between the corresponding adjacent two of the plurality of batteries, and flows out of between the corresponding adjacent two of the plurality of batteries in an opposite direction from an inflow direction of temperature regulating fluid.

4. The battery temperature regulating device according to claim 3, wherein a part of the first inter-battery passage into which temperature regulating fluid flows, and a part of the second inter-battery passage into which temperature regulating fluid flows are arranged diagonally on a passage formation surface of one of the corresponding adjacent two of the plurality of batteries.

5. The battery temperature regulating device according to claim 1, wherein:
the first inter-battery passage is a passage through which temperature regulating fluid flows in one direction from one side toward the other side of a passage formation surface of one of the corresponding adjacent two of the plurality of batteries;
the second inter-battery passage is a passage through which temperature regulating fluid flows in an opposite direction from a direction of temperature regulating fluid flowing through the first inter-battery passage from the other side toward the one side of the passage formation surface of one of the corresponding adjacent two of the plurality of batteries; and
each of the plurality of inter-battery passages further includes a third inter-battery passage through which temperature regulating fluid flowing through the first inter-battery passage and temperature regulating fluid flowing through the second inter-battery passage merge together to flow down.
